(19) United States
(12) Patent Application Publication
(10) Pub. No.: US 2011/0267925 A1
(43) Pub. Date: Nov. 3, 2011

(54) BOTTOM SEISMIC STATION

(76) Inventors: Andrej Vladimirovich Tulupov, Moscow (RU); Evgenij Dmitrievich Lisitsyn, St. Petersburg (RU); Vladimir Eduardovich Kyasper, St. Petersburg (RU); Yurij Georgievich Erofeev, Volzhsky (RU); Alexandr Dmitrievich Ivanenko, Murmansk (RU)

(21) Appl. No.: 12/734,272

(22) PCT Filed: Jan. 19, 2010
(86) PCT No.: PCT/RU2010/000018

§ 371 Date: Apr. 21, 2010

(30) Foreign Application Priority Data
Dec. 19, 2008 (RU) 2008150344

(51) Int. Cl. G01V 1/18

(52) U.S. Cl. 367/178

(57) ABSTRACT

The proposed bottom station relates to geophysical exploration, particularly to the geo-electrical seismic survey equipment. It's intended for prediction of hydrocarbons deposits and study of the deep structure of earth's crust. The station comprises a body, a load, a registration device. The station is characterized by placement of sensors in the lower part of body, in combination with the use of the load, having a cavity on the upper surface with a diameter exceeding the corresponding body's diameter. The body is releasably fastened to the load by means of Kevlar ropes. Additional accuracy of the station is achieved by the use of orthogonal three-component sensors, rather than cardan sensors, as well as by incorporating into the station's body an additional acoustic system for control of location of the station. Substitution of a hard drive by a flush memory card in the registration device increases reliability of storing and transmitting information.

### CROSS-REFERENCE TO RELATED APPLICATIONS

This application is a U.S. national phase application of a PCT application PCT/RU2010/000018 filed on 19 Jan. 2010, whose disclosure is incorporated herein in its entirety by reference, which PCT application claims priority of a Russian Federation Patent Application RU2008150344/22 filed on 19 Dec. 2008.

### FIELD OF THE INVENTION

The utility invention relates to the field of geophysical exploration, in particular, to the equipment for seismic survey. It is intended for prediction of the hydrocarbons deposits and study of the deep structure of the earth's crust.

### BACKGROUND OF THE INVENTION

At present, bottom stations of different design and purpose are widely used for the marine geophysical research. For example, bottom seismic stations (RU 24890; The deep-water bottom self-emerging seismic station ADS-8/Soloviev S. L., Kontar E. A., Dozorov T. A., Kovachev S. A. // Izvestiya of the Academy of Sciences of USSR, Physics of the Earth, 1988, 9, p. 459-460; Ocean Bottom Seismometer (OBS) stations. Company Profile Project Companies Kieler Umwelt und Meerestechnik GmbH (K.U.M.), Signal-Elektronik und Nets Dienste GmbH (SEND), April 2002, 11 p.) are known, based on an underwater module, which comprises a hermetic body, provided with a bottom setting device, with equipment for registration of the hydroacoustic signals, the equipment has inside filters, formers, converters, information storage devices, synchronization scheme, a power source and a device for determination of underwater orientation of the module.

The main disadvantage of such stations is the impossibility of complete and adequate transmission of the changing ground parameters to the signal measuring sensors, which sensors are placed on a support tubular frame, provided with drop mechanisms, capable of depressing the station to the ground, that in combination with a ground-metal interface layer causes additional inaccuracies during the passage of acoustic signals and finally leads to inaccurate results of the measurements. Moreover, the use of the drop mechanisms is not efficient enough due to their complexity, lack of setting control, that leads to getting the measuring sensors block into the bottom mellow ground and, as a consequence, to failure of operation of the station.

The most similar related art device to the claimed invention by its technical essence and the achieved effect is the bottom seismic station of [symbol] Sevmorgeo [symbol] construction (advertising booklet [symbol] Sevmorgeo [symbol] ). The station comprises a spherical hermetic body, containing: a cardan fixture, supporting geophones (displacement sensors), a power source, a data logger, an acoustic release mechanism of the electrochemical type, and an electronic block of the acoustic release. The hermetic body ensures positive floatability of the whole station. For setting the station on the bottom, it is fastened with elastic (rubber) braids through the release mechanism to a concrete load of rectangular shape.

Such construction ensures high usability of the round-trip operations, possibility of work at the depths up to 6000 meters. However, the high position of the displacement sensors with respect to the bottom and the elastic fastening of the station to the load, and the cardan fixture reduce the station's sensibility to offset waves.

### AIM AND SUMMARY OF THE INVENTION

The primary aim of the invention is to develop a more reliable and more sensitive bottom station. Other aims might become apparent to skilled artisans upon learning the present disclosure.

The aforementioned aim has been achieved by: (a) arranging the displacement sensors in a bottom portion of the body, which bottom portion having a predetermined convex shape; and (b) providing an anchor load (preferably made of concrete), the load includes an upper surface and a cavity, cut on the upper surface, the cavity having a concave shape corresponding to the convex shape of the bottom portion, such that the bottom portion is insertable into the cavity. The bottom portion is inserted into the cavity in such a way that the cavity prevents any movement of the station's body except the vertical lifting. The body is fastened to the load with the help of straps, preferably, Kevlar ropes. In preferred embodiment, additional measurement accuracy of the claimed station is achieved by the use of orthogonal three-component sensors, rather than a cardan fixture, as well as by incorporation of an acoustic system for additional control of location of the station into the station's body.

The station also includes a registration device. In some embodiments, substitution of a hard disk by a flush-memory device in the registration device increases reliability of the storage and transmission of information.

### BRIEF DESCRIPTION OF THE DRAWINGS

FIG. 1 is a general view of the inventive station.

FIG. 2 is a schematic view of arranging of basic elements in the body of the inventive station.

### DESCRIPTION OF THE PREFERRED EMBODIMENT

While the invention may be susceptible to embodiment in different forms, there is shown in the drawings, and will be described in detail herein, a specific embodiment of the present invention, with the understanding that the present disclosure is to be considered an exemplification of the principles of the invention, and is not intended to limit the invention to that as illustrated and described herein.

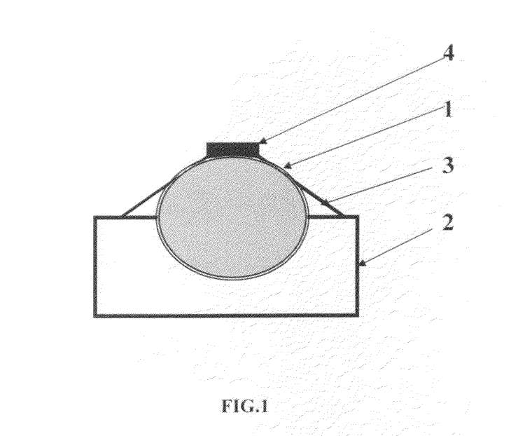

Some basic elements of the inventive station are shown on FIG. 1 and enumerated below:
a station body (1) of a preferably spherical or ellipsoid shape;
an anchor load (2), wherein the load 2 has a cavity cut on the upper surface thereof, such that the cavity's diameter exceeds a corresponding diameter of the body I in the plane of contact with the body 1;
straps (preferably, Kevlar ropes) (3) attached to the load 2;
a release mechanism (4) releasably attached to the Kevlar ropes 3, and placed preferably on the top of body 1.

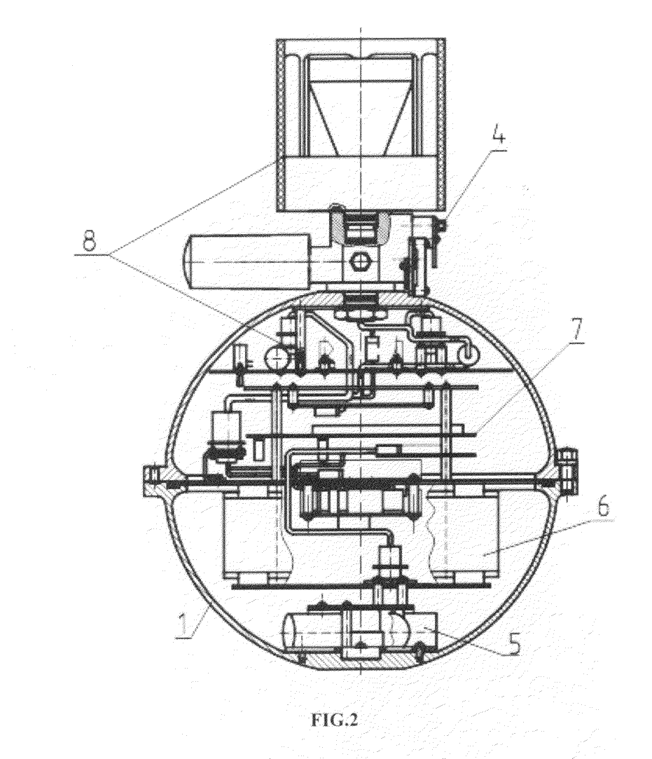

The station also comprises the following structural elements, presented on FIG. 2:
displacement sensors (5) preferably located at the bottom of body 1;
a power source (6) contained in the body 1;
a registration device (7) contained in the body 1;
an acoustic system (8), associated with the body 1.

### OPERATION OF THE PREFERRED EMBODIMENT

In the ready-to-use state (i.e. at-rest position), the station body 1 is set into the cavity of the load 2, in such a way that the bottom of the station body would be most closely placed to the common center of gravity of the station body 1 and the load 2 in the assembled condition. The body 1 is fastened to the load 2 with the help of the Kevlar un-stretchable ropes 3. The placement of the displacement sensors 5 in the station's center of gravity region increases the station sensibility to the registered offset waves. At arrival of a release signal to the release mechanism 4, it unfastens the ropes 3 releasing the station body 1, and then the station body 1 emerges.

### INDUSTRIAL APPLICATION

An exemplary embodiment of the seismic bottom station is actually built and named ‘EMMET OBS’, which is in particular characterized by:
presence of an orthogonal triplet of geophones and a hydrophone;
small dimensions (the sphere with the diameter of 250 mm is well circulated by the near-bottom currents);
significant autonomy, up to 30 days;
convenience of fitting out before setting onto the bottom profile (the simplest replacement of self-emersion cartridge and creation of vacuum in the body);
determination of the true position in space during operation;
rigid fastening of the geophones to the body that excludes parasitic oscillations;
simple and inexpensive construction of the anchor-load;
a possibility of setting different operation modes of the registration device 7 and different parameters of work before setting the station onto the sea bottom.
the use of lithium batteries ensuring necessary energy autonomy; and
small mass of the registration device, less than 8 kG that allows operating on a vessel's deck without bulky load-lifting mechanisms.

1. A bottom seismic station comprising:
a station body including a bottom portion thereof, said bottom portion having a predetermined convex shape;
an anchor load including an upper surface and a cavity, said cavity is cut in the upper surface, said cavity has a concave shape configured to cooperate with the convex shape of said bottom portion, such that the bottom portion is insertable into the cavity;
a plurality of straps, said straps have first ends attached to said load, and said straps have second ends;
and
a release mechanism releasably attached to the second ends of said straps, and said release mechanism is placed on top of said body.

2. The bottom seismic station according to claim 1, wherein said straps are made of Kevlar.

3. The bottom seismic station according to claim 1, further comprising orthogonal three-component sensors essentially placed in said bottom portion of the station.

4. The bottom seismic station according to claim 1, further comprising an acoustic system for additional control of location of the station, said acoustic system is essentially placed in said bottom portion of the station.

5. The bottom seismic station according to claim 1, further comprising a registration device.

6. The bottom seismic station according to claim 5, wherein said registration device includes a flush-memory device.
